(19) United States
(12) Patent Application Publication
(10) Pub. No.: US 2013/0086746 A1
(43) Pub. Date: Apr. 11, 2013

(54) PATIENT SUPPORT APPARATUS WITH MOVABLE SIDERAIL ASSEMBLY

(71) Applicant: Irvin J. VANDERPOHL, Greensburg, IN (US)

(72) Inventor: Irvin J. VANDERPOHL, Greensburg, IN (US)

(21) Appl. No.: 13/269,822

(22) Filed: Oct. 10, 2011

(51) Int. Cl. A47C 21/08; A61G 7/05

(52) U.S. Cl. 5/428

(57) ABSTRACT

A patient support apparatus includes a base, a frame coupled to the base, a deck supported by the frame and capable of moving relative to the frame, and a siderail assembly movable between a raised position above the deck and a lowered position below the deck. The siderail assembly includes a linkage coupled to the frame to move between the raised and the lowered positions and a barrier coupled to the linkage to move therewith.

### BACKGROUND

The present disclosure is related to a support apparatus for supporting a patient. More particularly, the present disclosure relates to a bed that includes one or more siderail assemblies coupled to the bed for movement relative to the bed between a raised position and a lowered position.

It is known to provided beds that have bases supporting the bed on ground underlying bed and frames which are movable relative to the base to change an elevation of the bed. Siderail assemblies may be coupled to the frames to retain patients resting on the support surface. The siderail assemblies may be movable from the raised position to the lowered position which is useful for transferring patients from the bed to another support apparatus, allowing a caregiver to access the patient, and for helping with entering or exiting the bed.

It is also known that when a patient is entering or exiting the bed, the bed is often lowered to the lowest elevation so that injury to the patient is minimized should the patient fall. The lowest elevation of the bed may be limited by the siderail assembly in the lowered position causing interference between the ground and the support surface, thereby limiting the lowest elevation of the support.

### SUMMARY

The present application discloses one or more of the features recited in the appended claims and/or the following features which, alone or in any combination, may comprise patentable subject matter.

According to one aspect of the present disclosure, a patient support apparatus may include a base, a frame coupled to the base to move relative to the base, a deck supported by the frame and movable relative to the frame, and a siderail assembly. The siderail assembly may include a linkage, a barrier, and a linkage mover. The linkage may be coupled to the frame below the deck to move relative to the frame between a raised position and a lowered position. The barrier may be coupled to the linkage to move relative to the linkage between a vertical position in which the barrier is in a vertical plane and a horizontal position in which the barrier is in a horizontal plane orthogonal with the vertical plane. The linkage mover may interconnect the linkage and the frame to cause the linkage and the barrier to move between the raised and lowered positions when the barrier is in one of the vertical and horizontal position.

In some embodiments, the linkage mover may include a support plate, an actuator, and a link arm. The support plate may be coupled to the frame in a fixed position. The actuator may be coupled to the support plate to move relative to the support plate between an extended position in which the actuator has an extended length and a retracted position in which the actuator has a retracted length. The link arm may interconnect the linkage and the actuator to cause the linkage to move from the lowered position to the raised position in response to movement of the actuator to the retracted position to the extended position.

In some embodiments, the extended length of the actuator may be greater than the retracted length.

In some embodiments, the siderail assembly may be in a vertical raised position when the barrier is in the vertical position and the linkage is in the raised position.

In some embodiments, the barrier may be spaced apart above ground a first distance when the siderail assembly is in the vertical raised position.

In some embodiments, the siderail assembly may be in a vertical lowered position when the barrier is in the vertical position and the linkage is in the lowered position.

In some embodiments, the barrier may be spaced apart above ground a second distance when the siderail assembly is in the vertical lowered position and the second distance is less than the first distance.

In some embodiments, the siderail assembly may be in a horizontal raised position when the barrier is in the horizontal position and the linkage is in the raised position.

In some embodiments, the barrier may be spaced apart above ground a first distance when the siderail assembly is in the horizontal raised position.

In some embodiments, the siderail assembly may be in a horizontal lowered position when the barrier is in the horizontal position and the linkage is in the lowered position.

In some embodiments, the barrier may be spaced apart above ground a second distance when the siderail assembly is in the horizontal lowered position and the second distance is less than the first distance.

In some embodiments, the siderail assembly may further include a barrier lock unit including a barrier lock movable between a locked position and a freed position. When the barrier lock is in locked position, the barrier may be blocked from moving relative to the linkage. When the barrier lock is in the freed position, the barrier may be free to move relative to the linkage.

In some embodiments, the lock unit may further include a lock controller. The lock controller may includes an actuator, a relay, and a lock mover. The actuator may be coupled to the barrier to pivot about an actuator pivot axis between an engaged position and a disengaged position. The lock mover may be coupled to the barrier to move the barrier lock from the locked to the freed position in response to the relay providing electrical power to the lock mover in response to movement of the actuator from the disengaged position to the engaged position.

In another aspect of the present disclosure, a patient support apparatus may include a base, a frame coupled to the base to move relative to the base, a deck supported by the frame and movable relative to the frame, and a siderail assembly. The siderail assembly may include a linkage, a barrier, and a linkage mover. The linkage may be coupled to the frame below the deck to move relative to the frame between a raised position and a lowered position. The barrier may coupled to the linkage to pivot about a barrier axis relative to the linkage between a vertical position in which an inner surface of the barrier that faces the deck defines a vertical plane and a horizontal position in which the inner surface of the barrier defines a horizontal plane orthogonal with the vertical plane. The linkage mover may interconnect the linkage and the frame to cause the barrier to move from the raised position in which the barrier is a first distance above ground to the lowered position in which the barrier is a smaller second distance above ground.

In some embodiments, the inner surface of the barrier may remain parallel to the vertical plane during movement of the barrier between the raised and the lowered position when the barrier is in the vertical position.

In some embodiments, the inner surface of the barrier may remain parallel to the horizontal plane during movement of the barrier between raised and the lowered position when the barrier is in the horizontal position.

In some embodiments, the linkage mover may include a support plate, an actuator, and link arm. The support plate may be coupled to the frame in a fixed position. The actuator may be coupled to the support plate to move relative to the support plate between an extended position in which the actuator has an extended length and a retracted position in which the actuator has a retracted length. The link arm may interconnect the linkage and the actuator to cause the linkage to move from the lowered position to the raised position in response to movement of the actuator from the retracted position to the extended position. The actuator may have a first end coupled to the support plate to pivot about a first pivot axis and a second end coupled to the linkage to pivot about a second pivot axis. The first pivot axis may be fixed relative to the support plate and the second pivot axis may move along an arcuate slot formed in the support plate relative to the support plate as the actuator moves from the retracted position to the extended position.

In some embodiments, the actuator may be powered. The actuator may be powered by electricity. The actuator may be powered by pressurized fluid.

In another aspect of the present disclosure, a patient support apparatus may comprise a base, a frame, a deck, and a seating unit. The base may include two long sides spaced apart from one another and two short sides spaced apart from one another and interconnecting the two long sides. The frame may be coupled to the base to move relative to the base. The deck may be supported by the frame and may be movable relative to the frame. The seating unit may include a seat support, a seat, and a seat pivot. The seat support may be coupled to the base to pivot about a vertical pivot axis between a first position in which the seat support extends along a long side of the frame and second position in which the seat support extends away from the two long sides. The seat pivot may interconnect the seat and the seat support to cause the seat to pivot about a horizontal seat pivot axis between a horizontal position in which a support surface of the seat adapted to support a user sitting on the seat defines a generally horizontal plane and a vertical position in which the support surface defines a generally vertical plane. The seating unit may be in a storage position when the seat is in the vertical position and the seat support is in the first position. The seating unit may be in an intermediate position when the seat is in the vertical position and the seat support is in the second position. The seating unit may be in a use position when the seat is in the horizontal position and the seat support is in the second position.

In some embodiments, the seating unit may further include an actuator coupled to the seat support and to the seat to cause the seat to pivot from the vertical position to the horizontal position upon extension of the actuator from a first length to a second length greater than the first length.

In some embodiments, the seating unit may further include a seat-support lock coupled to the base to block selectively movement of the seat support.

Additional features, which alone or in combination with any other feature(s), including those listed above, those listed in the claims, and those described in detail below, may comprise patentable subject matter. Other features will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of a first embodiment of a patient support apparatus in a generally flat configuration with four siderail assemblies in a raised position;

FIG. 2 is a view similar to FIG. 1 with one foot siderail assembly in a vertical raised position and the other foot siderail assembly in a horizontal raised position;

FIG. 3 is a view similar to FIG. 2 with one foot siderail assembly in the vertical raised position and the other foot siderail moved to a horizontal lowered position;

FIG. 4 is a view similar to FIG. 3 with one foot siderail in the vertical raised position and the other foot siderail moved to a vertical lowered position;

FIG. 5 is an enlarged partial perspective view of one of the foot siderail assemblies in the vertical raised position;

FIG. 6 is a view similar to FIG. 5 with the foot siderail assembly in the horizontal raised position;

FIG. 7 is a view similar to FIG. 6 with the foot siderail assembly in the horizontal lowered position;

FIG. 8 is a view similar to FIG. 7 with the foot siderail assembly in the vertical lowered position;

FIG. 9 is a an enlarged partial perspective view of a foot siderail assembly with portions shown in phantom showing an embodiment of a lock unit included in the siderail assembly that may be used to block movement of the siderail assembly between the vertical and the horizontal position;

FIG. 10 is an enlarged partial perspective view of a barrier lock included in the lock unit in an unlocked position;

FIG. 11 is a section view taken along line 11-11 of FIG. 1;

FIG. 12 is a section view taken along line 12-12 of FIG. 2;

FIG. 13 is a section view taken along line 13-13 of FIG. 3;

FIG. 14 is a section view taken along line 14-14 of FIG. 4;

FIG. 15 is a partial perspective view of another embodiment of a patient support apparatus that includes a movable seating unit arranged in a storage position and movable by way of a powered actuator;

FIG. 16 is a view similar to FIG. 15 with the movable seating unit rotated to an intermediate position;

FIG. 17 is a view similar to FIG. 16 with the movable seating unit in a use position; and

FIG. 18 is a partial perspective view of another embodiment of a patient support apparatus that includes a movable seating unit arranged in a use position and is movable manually.

### DETAILED DESCRIPTION OF THE DRAWINGS

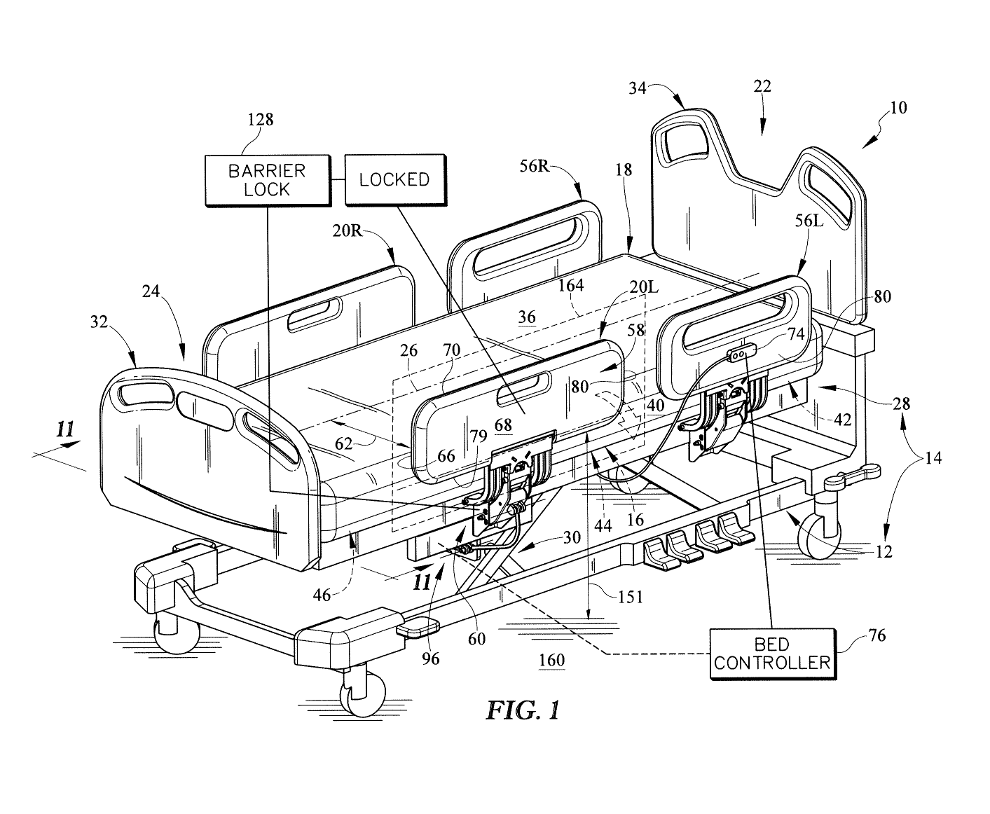

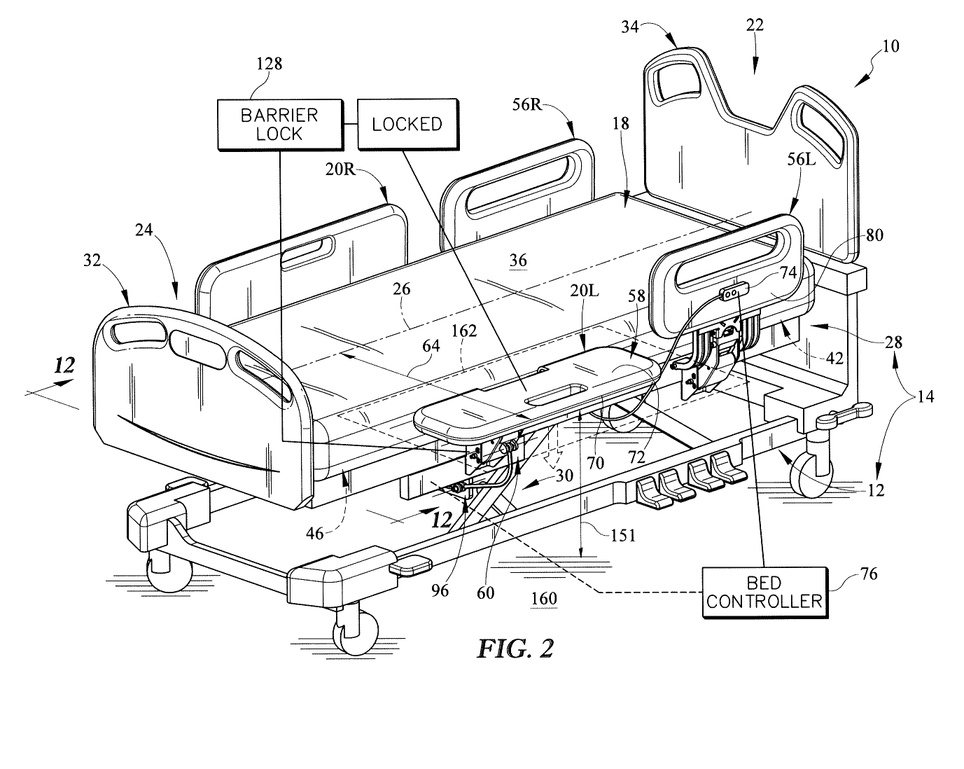

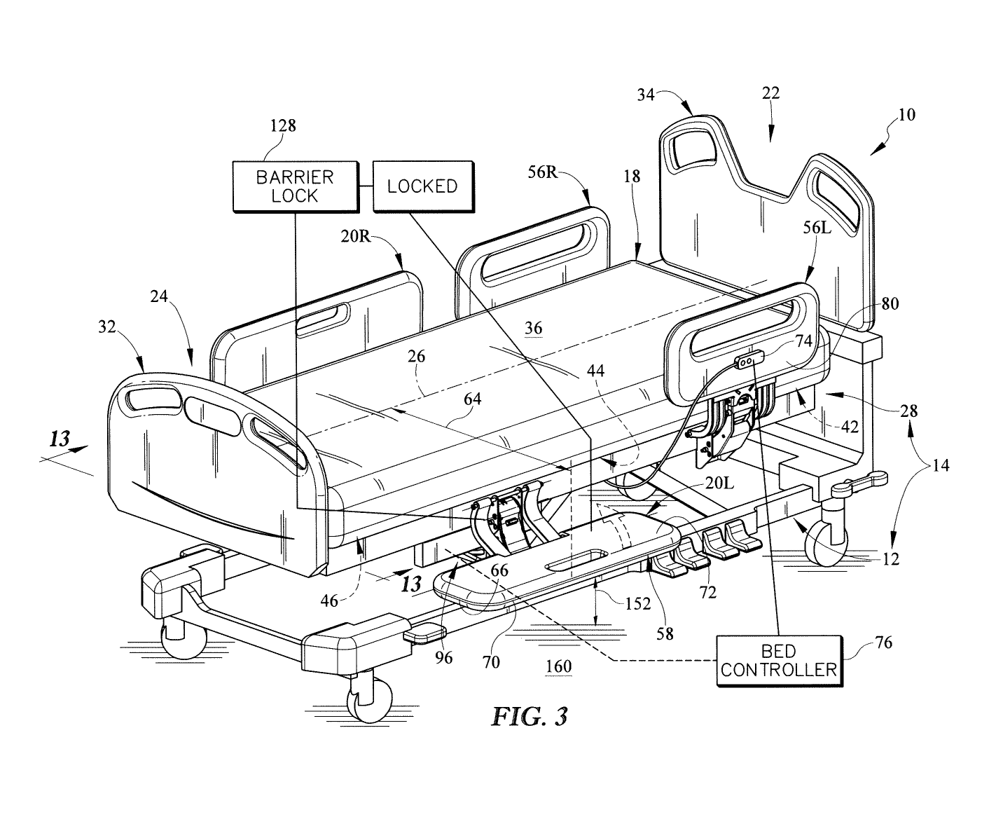

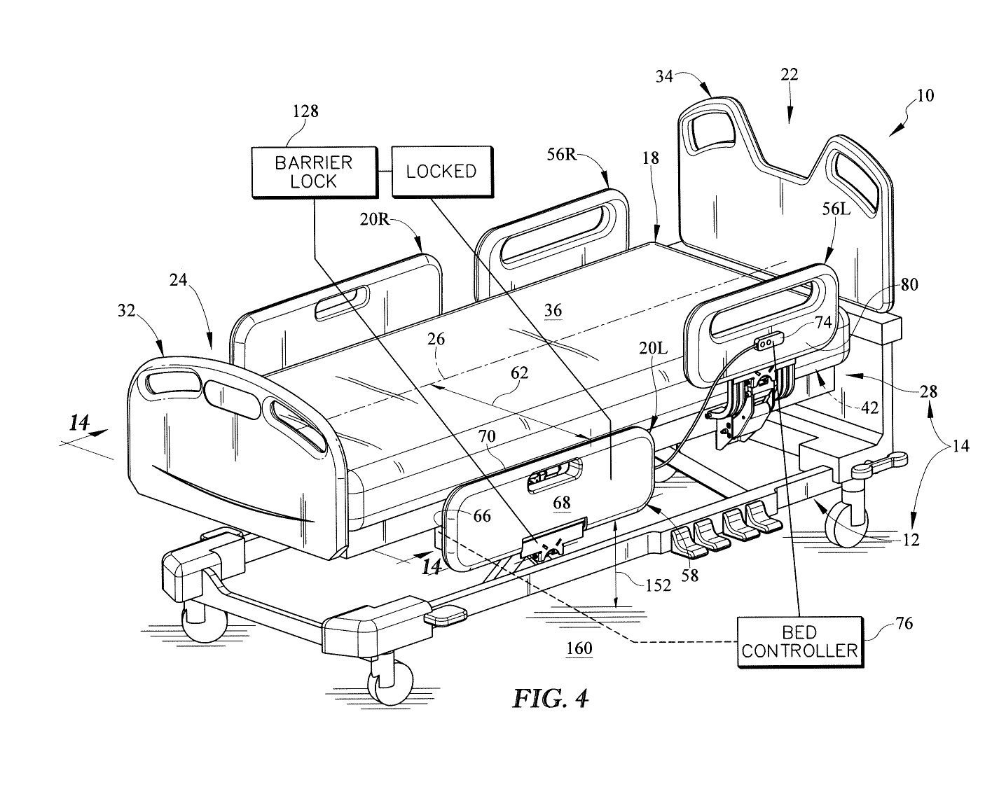

A patient support apparatus, illustratively embodied as a hospital bed 10, comprises a frame 14, a deck 16, and a mattress 18 as shown in FIG. 1. The mattress 18 is supported by the deck 16 which is articulatable relative to the frame 14. The bed 10 is movable between a horizontal bed position in which the deck 16 is generally flat as shown in FIG. 1 and a chair-egress position in which the deck 16 is articulated so that the bed 10 is configured to allow a patient to egress or exit the bed 10 from a sitting position. The bed 10 also includes a patient-right foot siderail assembly 20R shown in a vertical raised position in FIGS. 1 and 4 and a patient-left foot siderail assembly 20L shown in a horizontal raised position in FIG. 2. The foot siderail assemblies 20R, 20L are further movable from the horizontal raised position of FIG. 2 to a horizontal lowered position in FIG. 3 and a vertical lowered position in FIG. 4.

The hospital bed 10 has a head end 22 and a foot end 24 and a longitudinal axis 26 that extends therebetween. The frame 14 includes a base 12 and an upper frame 28 coupled to the base 12 by an elevation system 30. The elevation system 30 is operable to raise, lower, and tilt the upper frame 28 relative to the base 12. The hospital bed 10 further includes a foot panel 32 positioned adjacent the foot end 24 and a head panel 34 positioned adjacent the head end 22.

The mattress 18 of the hospital bed 10 includes a top surface 36, a bottom surface 38, and a perimeter surface 40 as shown in FIGS. 1-4 and 11-14. The upper frame 28 of the frame 14 supports the deck 16 with the mattress 18 supported on the deck 16. The deck 16, as shown in FIGS. 1 and 2, includes a head section 42, a seat section 44, and a foot section 46. The head section 42 moves about a first lateral pivot axis relative to the upper frame 28. Additionally, the foot section 46 moves about a second lateral pivot axis relative to the upper frame 28. Also, the foot section 46 is extendable and retractable to change an overall length of the foot section 46, and therefore, to change an overall length of the deck 16.

In some embodiments, the seat section 44 also moves, such as by translating on the upper frame 28, as the hospital bed 10 moves between the bed position and the chair-egress position. In those embodiments where the seat section 44 translates along the upper frame 28, the foot section 46 also translates along with the seat section 44. As the hospital bed 10 moves from the bed position to the chair-egress position, the foot section 46 lowers about the second lateral pivot axis relative to the upper frame 28 and shortens in length. As the hospital bed 10 moves from the chair-egress position to the bed position, the foot section 46 raises relative to the seat section 44 and increases in length. Thus, in the chair-egress position, the head section 42 extends generally vertically upwardly from the upper frame 28 and the foot section 46 extends generally downwardly from the upper frame 28 as shown in FIG. 2.

The seat section 44 includes a foot edge, an opposite head edge, a first longitudinal edge 48, a second longitudinal edge, a top surface 52, and an opposite bottom surface 54 as shown in FIGS. 2 and 11-14. The foot edge is spaced-apart from and opposite the head edge. The first longitudinal edge 48 is spaced-apart from and opposite the second longitudinal edge the siderail assembly 20L is coupled along the first longitudinal edge 48. The first and second longitudinal edges 48 extend between the head and the foot edges. The top surface 52 is arranged to face in an upward direction. The bottom surface 54 is spaced-apart below the top surface 52, is arranged to face in an opposite downward direction. The first and second lateral pivot axes are parallel to the head edge and the foot edge.

The hospital bed 10 also includes four siderail assemblies coupled to the upper frame 28: a patient-right head siderail assembly 56R, the patient-right foot siderail assembly 20R, the patient-left head siderail assembly 56L, and the patient-left foot siderail assembly 20L. The siderail assemblies 20R, 20L, 56R, and 56L are sometimes referred to as siderails 20R, 20L, 56R, and 56L herein. As shown in FIGS. 1 and 2, the patient-left foot siderail 20L is spaced-apart from and arranged to extend along the first longitudinal edge 48 of the seat section 44.

The patient-left foot siderail 20L is similar to the patient-right foot siderail 20R, and thus, the following discussion of the patient-left foot siderail 20L is equally applicable to the patient-right foot siderail 20R. The siderail 20L includes a barrier 58 and a linkage 60 that is configured to guide the barrier 58 during movement of the siderail 20L between the raised and the lowered positions. The linkage 60 interconnects the barrier 58 and the upper frame 28 to cause the barrier 58 to remain in the substantially vertical position as shown in FIGS. 1 and 4 and the substantially horizontal position as shown in FIGS. 2 and 3 during movement between the raised and the lowered positions.

As shown in FIGS. 1 and 4, the hospital bed 10 has a first dimension 62 when the siderail assembly 20L is in one of the vertical raised position or the vertical lowered position. As shown in FIGS. 2 and 3, the hospital bed 10 has as second dimension 64 when the siderail assembly 20L is in one of the horizontal raised position or the horizontal lowered position. The first dimension 62 is measured between the longitudinal axis 26 and an outermost edge of the barrier 58. As an example, the outermost edge of the barrier 58 is an outer side 68 of the barrier 58 when the barrier 58 is in the vertical position as shown in FIGS. 1 and 4. In comparison, the outermost edge of the barrier 58 is a top side 70 of the barrier when the barrier 58 is in the horizontal position as shown in FIGS. 2 and 3. The first dimension 62 is less than the second dimension 64.

As discussed above, the barrier 58 includes the outer side 68 and an oppositely facing inner side 72. As shown in FIGS. 1 and 4, the inner side 72 faces toward the mattress 18 and the outer side 68 faces away from the mattress 18 when the barrier 58 is in the vertical position and the barrier 58 lies in a generally vertical plane 164. When the barrier is in the horizontal position, the inner side 72 faces upwardly and the outer side faces downwardly and the barrier 58 lies in a generally horizontal plane 162 as shown in FIG. 2. The barrier 58 also includes a foot side 78, a head side 80, a bottom side 79, and the top side 70. The foot side 78 faces the foot end 24 of the hospital bed 10. The head side 80 faces toward the head end 22 of the hospital bed 10. The top side 70 extends between and interconnects the foot side 78 and the head side 80 and the outer and inner sides 68, 72. The bottom side 79 faces opposite the top side.

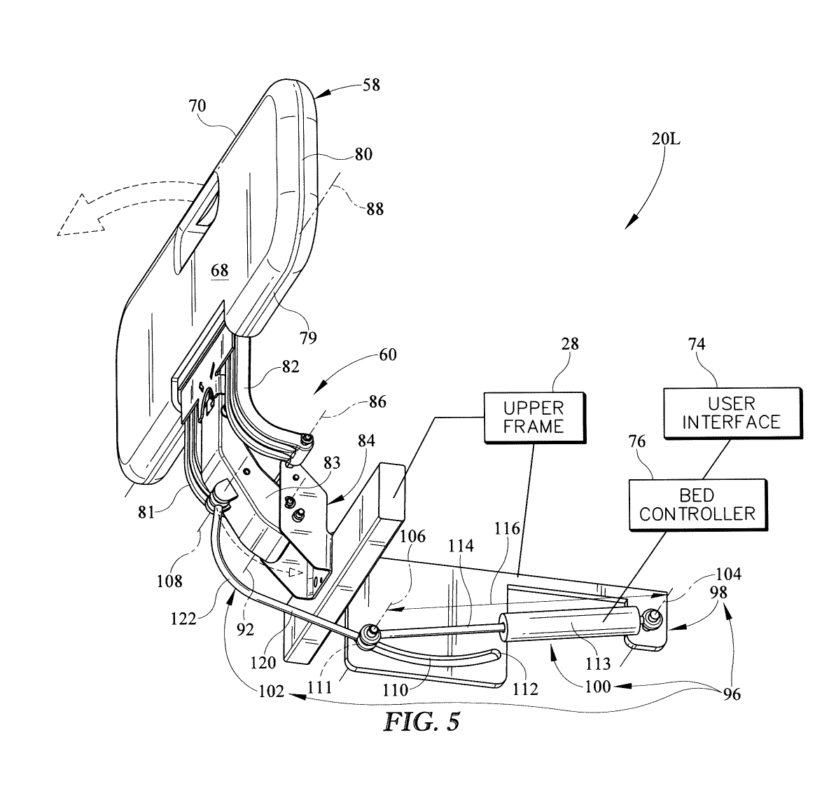

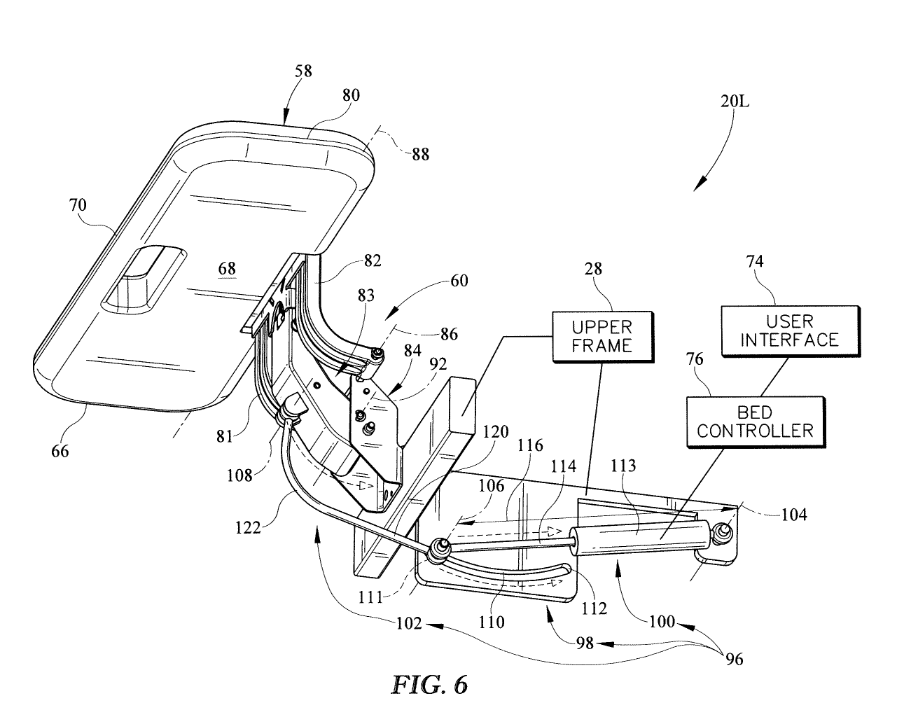

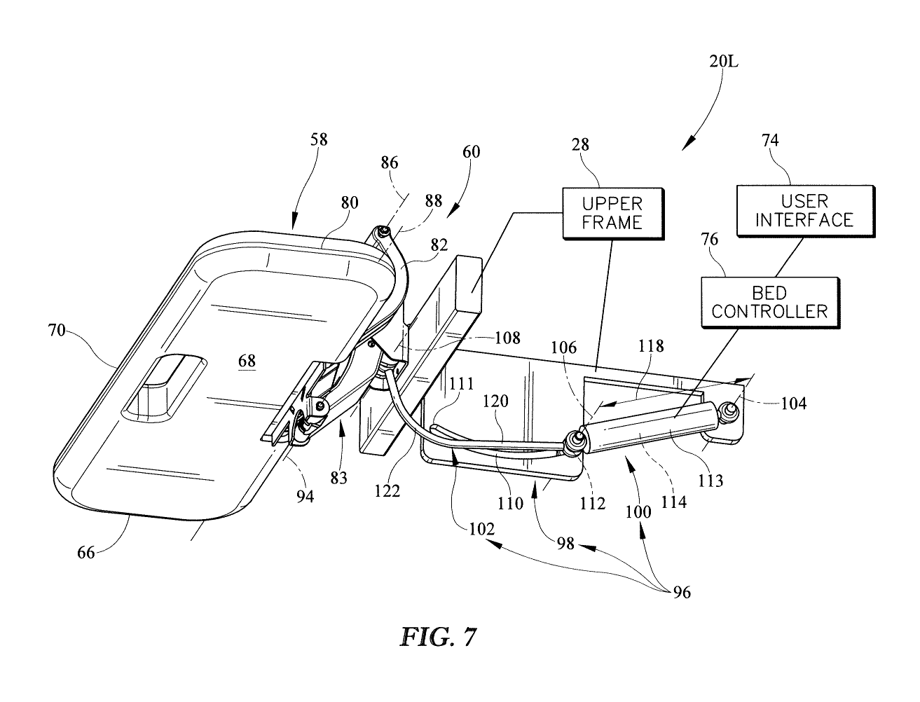

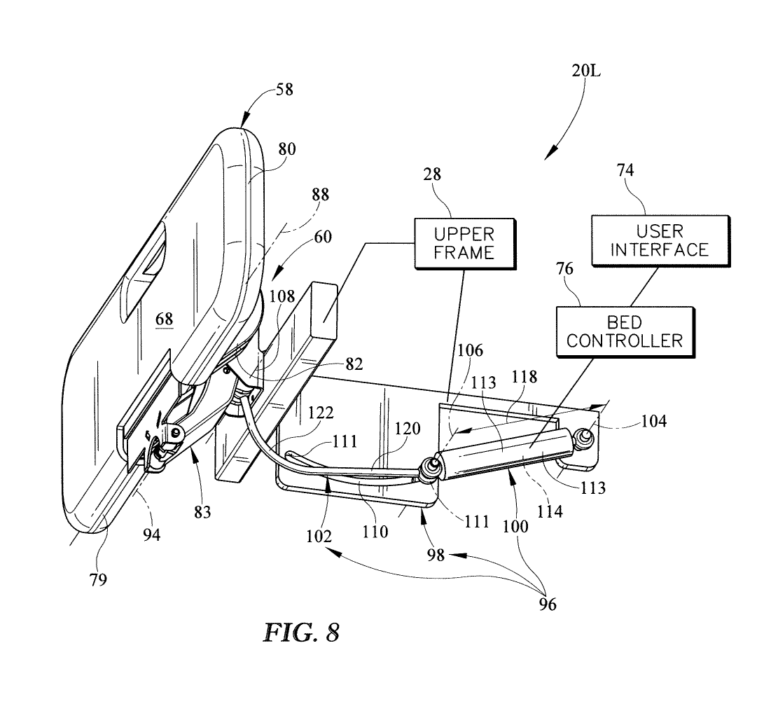

The linkage 60 includes a first upper link 81, a second upper link 82, a lower link 83, and a mount bracket 84 as shown in FIGS. 5-8. The mount bracket 84 is coupled to the upper frame 28 in a fixed position. The first upper link 81 is coupled to the mount bracket 84 on a first end to pivot about a first upper-link pivot axis 86 as shown in FIGS. 5-8. The second upper link 82 is coupled to the mount bracket 84 on a first end in spaced apart relation to the first upper link 81 to pivot about the first upper-link pivot axis 86 as shown in FIGS. 5-8. The barrier 58 is coupled to both the first and second upper links 81, 82 to pivot about a second upper-link pivot axis 88 which is also called a barrier axis 88 between the vertical position of FIGS. 5 and 8 and the horizontal position of FIGS. 6 and 7.

The lower link 83 is coupled to the mount bracket on a first end to pivot about a first lower-link pivot axis 92 as shown in FIGS. 5-8. The barrier 58 is coupled to the lower link 83 on an opposite second end to pivot about a second lower-link pivot axis 94 as shown in FIGS. 5-9. The lower link 83 is positioned between the first and second upper links 81, 82. When the linkage 60 is in the raised position, the second upper-link pivot axis 88 is positioned to lie in spaced-apart relation above the first lower-link pivot axis 92. At the same time, the first upper-link pivot axis 86 is positioned to lie in spaced-apart relation above the first lower-link pivot axis 92 and lie between the first lower-link pivot axis 92 and the second lower-link pivot axis 94. The second lower-link pivot axis 94 is positioned to lie in spaced-apart relation to the first lower-link pivot axis 92 and is positioned to lie between the first lower-link pivot axis 92 and the second upper-link pivot axis 88.

As shown in FIGS. 5-8, siderail assembly 20L further includes a linkage mover 96. The linkage mover 96 interconnects the linkage 60 and the frame 14 to cause the linkage 60 and the barrier 58 to move together between the raised and the lowered positions. As an example, the linkage mover 96 causes the barrier 58 and the linkage 60 to move regardless of the position of the position of the barrier 58 relative to the linkage 60.

The linkage mover 96 illustratively includes a support plate 98, an actuator 100, and a link arm 102 as shown in FIGS. 5-8. The support plate 98 is coupled to the frame 14 in a fixed position relative to the frame 14. The actuator 100 is coupled on a first end to the support plate 98 to pivot about a first axis 104 which is generally parallel to the longitudinal axis 26 of the hospital bed 10. The actuator 100 is coupled on an opposite second end to the link arm 102 to cause the link arm to move relative to the actuator 100 as the actuator moves between an extended position shown in FIGS. 5 and 6 and a retracted position shown in FIGS. 7 and 8. A first end of the link arm 102 is coupled to the second end of the actuator 100 to pivot about a second axis 106 as shown in FIGS. 5-8. A second end of the link arm 102 is coupled to the lower link 83 of the linkage 60 to pivot about a third axis 108 as the linkage moves between the raised and the lowered positions.

The support plate 98, for example, is coupled to the upper frame 28 in a fixed position and arranged to extend between the longitudinal axis 26 of the hospital bed and the first longitudinal edge 48 of the seat section 44 as suggested in FIGS. 5-8. Support plate 98 is formed to include a slot 110 as shown in FIG. 5. The slot 110 illustratively has an arcuate shape that curves upwardly. The second end of the actuator 100 couples to the first end of the link arm 102 and is constrained to move along the slot 110 as the actuator moves between the extended and retracted positions. The second axis 106 extends through the slot 110 and moves from a first slot end 111 of the slot 110 when the linkage 60 is in the raised position as shown in FIGS. 5 and 6 to a second slot end 112 of the slot 110 when the linkage 60 is in the lowered position as shown in FIGS. 7 and 8.

The actuator 100 is, for example, a powered actuator. As another example, the powered actuator may be a hydraulic cylinder, but may be a linear actuator or other suitable alternative. In an illustrative embodiment, actuator 100 includes a cylinder 113 coupled to the support plate 98 to pivot about the first axis 104 and a rod 114 coupled to the cylinder 113 to move in and out of the cylinder 113 to be in one of the extended position shown in FIGS. 5 and 6 and the retracted position shown in FIGS. 7 and 8. When the actuator 100 is in the extended position, the actuator has an extended length 116. When the actuator is in the retracted position, the actuator has a retracted length 118. The refracted length is less than the extended length.

The link arm 102 is arranged to interconnect the rod 114 of the actuator 100 and the lower link 83 of the linkage 60 as shown in FIGS. 5-8. Movement of the actuator 100 from the extended position of FIG. 6 to the retracted position of FIG. 7 causes the link arm 102 to move therewith in turn causing the linkage to move from the raised position to the lowered position. As shown in FIG. 5, the link arm has a straight portion 120 and a curved portion 122. The curved portion 122 is positioned to lie between the lower link 83 and the straight portion 120 as shown in FIG. 5. The straight portion is positioned to lie between the curved portion 122 and the rod 114 of the actuator 100.

A user interface 74 is coupled to an outer side 80 of the patient-left head siderail assembly 56L for use by a caregiver (not shown) as shown in FIGS. 1-4. The user interface 74 is coupled electrically to a bed controller 76 included in the hospital bed 10 and shown in FIGS. 1-4. Bed controller 76 is coupled electrically to actuator 100 and is configured to command the actuator 100 to move between the extended and retracted positions. As an example of use, patients and caregivers are able to control movement of the linkage 60 between the raised and lowered positions by using user interface 74 to input commands which are communicated to the bed controller 76 which in turn commands the actuator 100 to move as desired.

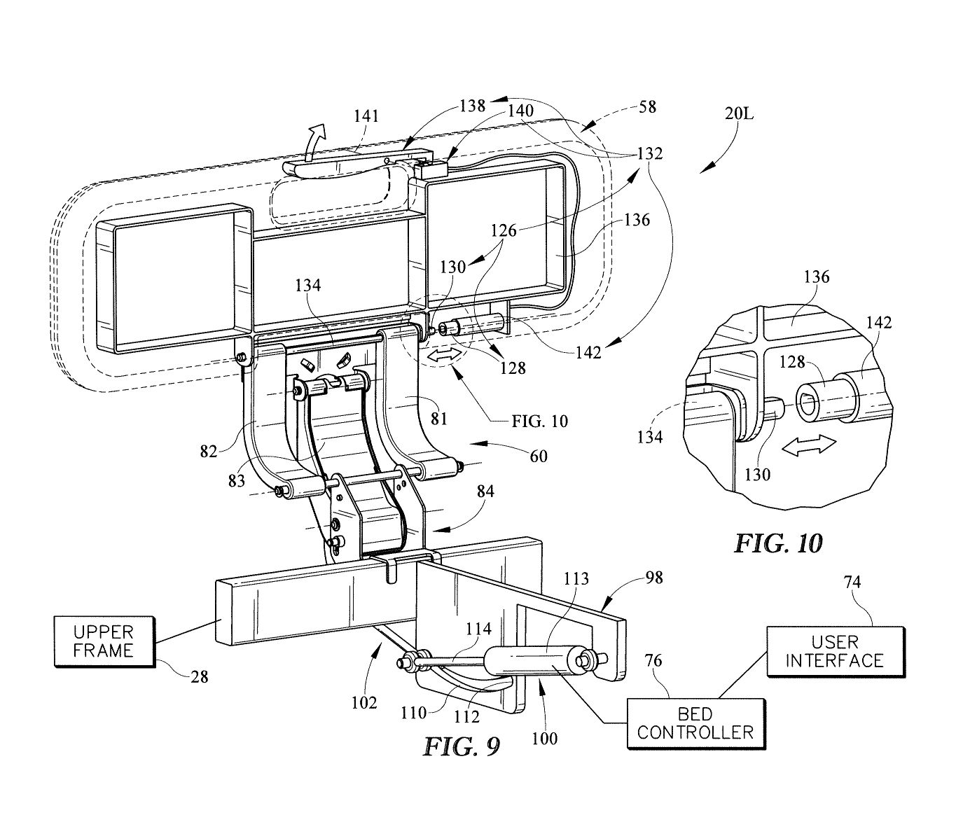

Movement of the barrier 58 is controlled by a lock unit 126 as shown diagrammatically in FIGS. 1-4 and shown illustratively in FIG. 9. The lock unit 126 includes a barrier lock 128, a barrier-lock receiver 130, and a lock controller 132 that is configured to control movement of the barrier lock 128 between a locked position and a freed position as suggested in FIG. 9. The barrier-lock receiver 130 is coupled to a linkage axle 134 include in the linkage 60 in a fixed position relative to the linkage 60. The barrier lock 128 is coupled to the barrier frame 136 to move relative to the barrier frame 136 between the locked position in which the barrier 58 is blocked from moving relative to the linkage 60 and the freed position in which the barrier 58 is free to move relative to the linkage 60.

The lock controller 132 includes an actuator 138, a relay 140, and a lock mover 142 as shown in FIG. 9. The actuator 138 is coupled to the barrier 58 to pivot about an actuator pivot axis 141 between an engaged position shown in FIG. 9 to a disengaged position (not shown). When the actuator 138 is in the engaged position, the relay 140 provides electrical power to the lock mover 142 that causes the lock mover 142 to move the barrier lock 128 against a biasing force provided by a spring from the locked position to the freed position shown in FIGS. 9 and 10. When the actuator 138 is in the disengaged position, the relay 140 blocks electrical power from going to the lock mover 142 which allows the barrier lock 128 to be returned to the locked position by the bias force. The actuator 138 is also biased toward the disengaged position in by a bias force which is provided a spring for example.

In one embodiment, the barrier 58 may be locked in the horizontal position by a barrier lock engaging with a barrier lock receiver. As an example, the barrier lock may be formed to include a shape that is configured to mate with the barrier-lock receiver in only the horizontal position and the vertical position. As a result, the barrier 58 is blocked from rotating between the horizontal and vertical positions when the barrier lock is in the locked position and movement between the horizontal and vertical positions is only permitted when the barrier lock is in the freed position spaced-apart from the barrier-lock receiver. In one exemplary embodiment, the barrier-lock receiver may be formed to have a D-shape while the barrier lock may be formed to have a double-D-shape that mates with the D-shaped barrier-lock receiver only when the barrier 58 is in the vertical position or the horizontal position.

In another embodiment, the barrier 58 is at 90 degrees of rotation when the barrier 58 is in the vertical position. The barrier 58 is at 0 degrees of rotation when the barrier 58 is in the horizontal position. Rotation of the barrier 58 about the barrier axis 88 beyond the horizontal position may be blocked by a barrier blocker. As an example, the barrier blocker may be coupled to the first or second upper links 81, 82 and configured to block rotation of the barrier 58 beyond the horizontal position. In an example of use, the caregiver would only engage the actuator 138 of the lock controller 132 to move the barrier 58 from the vertical position to the horizontal position. In moving the barrier from the horizontal position to the vertical position, the barrier lock 128 would automatically re-engage the barrier-lock receiver 130 once the barrier 58 reaches the vertical position.

In still yet another embodiment, the lock controller of lock unit 126 may be a manual actuator that is configured to be manipulated by the caregiver. As a result of moving the manual actuator to the engaged position, the barrier lock is moved to the freed position spaced apart from the barrier-lock receiver. The manual actuator may be biased toward the disengaged position so that the barrier lock is biased toward the locked position in mating contact with the lock receiver.

In an example of use, a caregiver first engages the actuator 138 of the lock controller 132 causing the barrier lock 128 to move from the locked position to the freed position of FIG. 10. The caregiver then rotates the barrier 58 about the second upper-link pivot axis 88 from the vertical position of FIGS. 1 and 5 to the horizontal position of FIGS. 2 and 6.

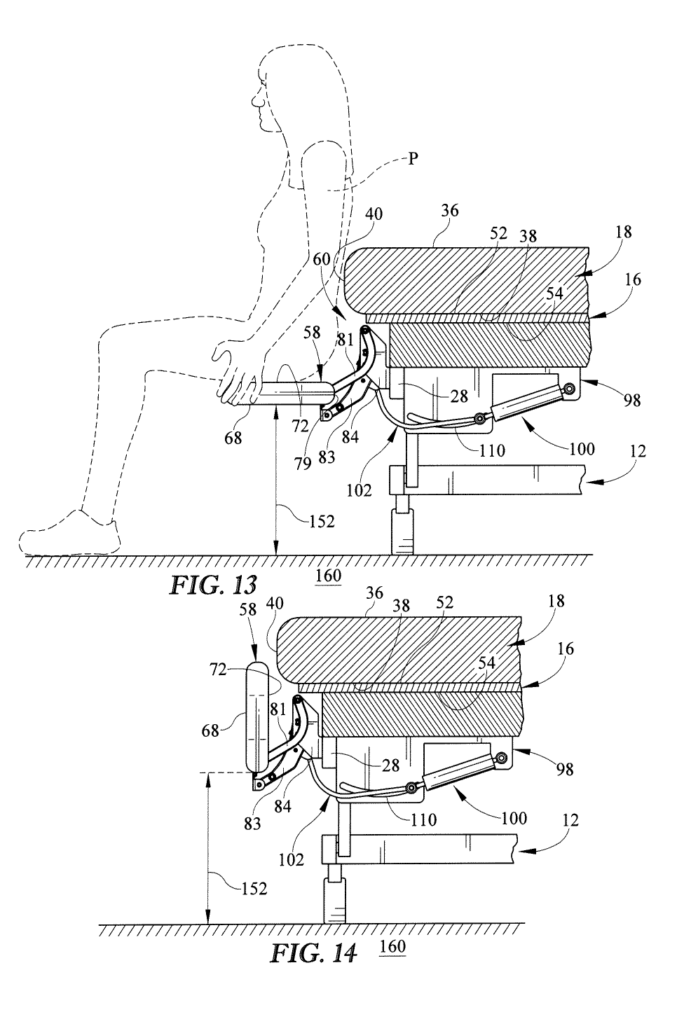

Next, the caregiver helps a patient P (shown in phantom) resting in the hospital bed 10 move from resting on the mattress 18 to sitting on the inner side 72 of the barrier 58 with their legs dangling above ground as shown in FIG. 12. When the siderail 20L is in the raised position, the siderail 20L is a first height 151 above the ground 160. The caregiver or patient then uses the user interface 74 to command the actuator 100 via bed controller 76 to move from the extended position to the retracted position causing the linkage 60 to move from the raised position to the lowered position as shown in FIG. 13. The siderail assembly 20L has moved from the horizontal raised position to the horizontal lowered position. The patient may now egress from the hospital bed 10 from a second height 152 above ground which may minimize injury should the patient fall.

The caregiver may then re-engage the actuator 138 of the lock controller 132 causing the barrier lock 128 to move from the locked position to the unlocked position. As a result, the caregiver may move the barrier 58 from the horizontal position to the vertical position as shown in FIGS. 4, 8, and 14. Now, the siderail assembly 20L is in the vertical lowered position which may be suitable for moving the hospital bed through doorways or other spaces in which the overall width of the hospital bed should be minimized. Finally, the caregiver disengages the actuator 138 allowing the barrier lock 128 to return to the locked position.

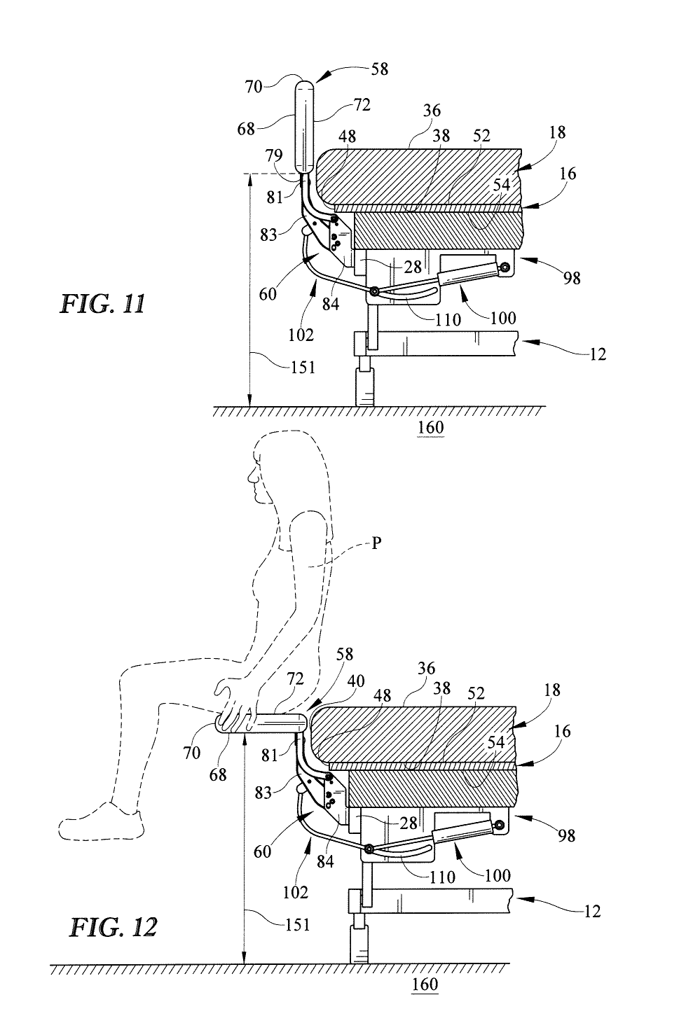

The siderail 20L is the first dimension 62 away from the longitudinal axis 26 and the first height 151 above the ground 160 when the siderail 20L is in the vertical raised position as shown in FIGS. 1 and 11. The first height 151 is defined between the bottom side 79 of the barrier 58 and the ground 160. The siderail 20L is the second dimension 64 away from the longitudinal axis and the first height 151 above the ground 160 when the siderail 20L is in the horizontal raised position as shown in FIGS. 2 and 12. The siderail 20L is the second distance 64 from the longitudinal axis 26 and a second height 152 above the ground 160 when the siderail 20L is in the horizontal lowered position as shown in FIGS. 3 and 13. The second height is defined between the outer side 68 of the barrier and the ground 160. The siderail 20L is in the first distance 62 away from the longitudinal axis 26 and the second height above ground when the siderail 27L is in the vertical lowered position as shown in FIGS. 4 and 14.

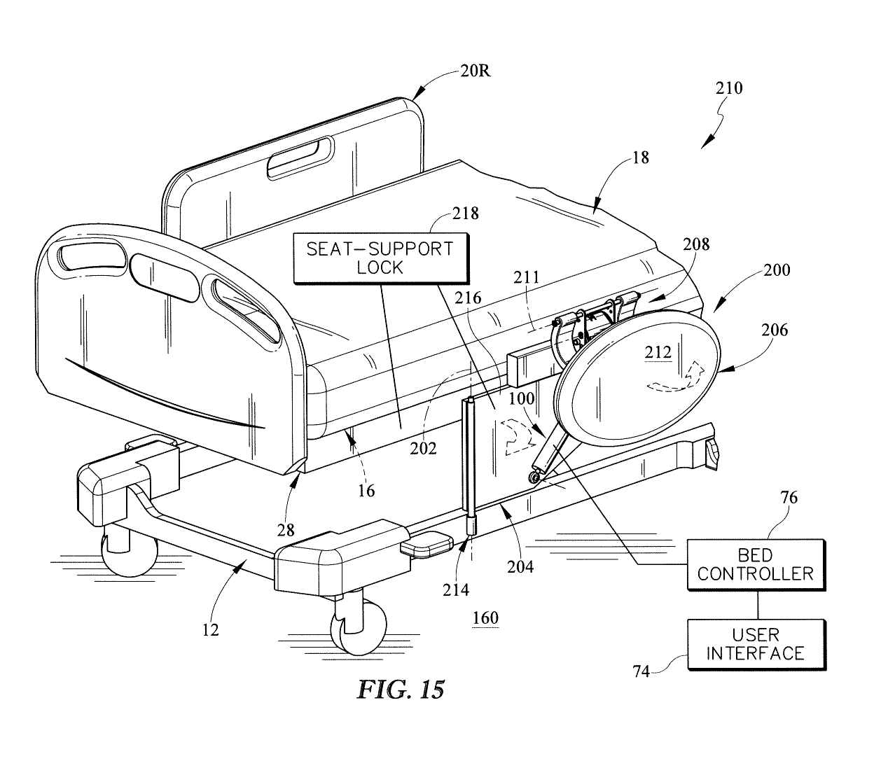

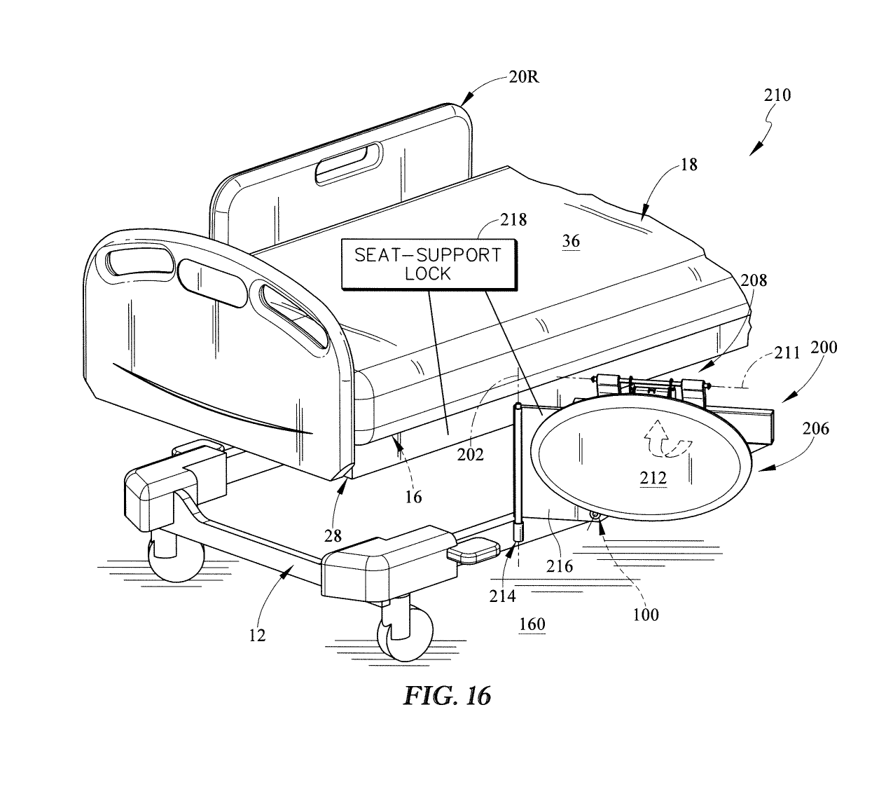

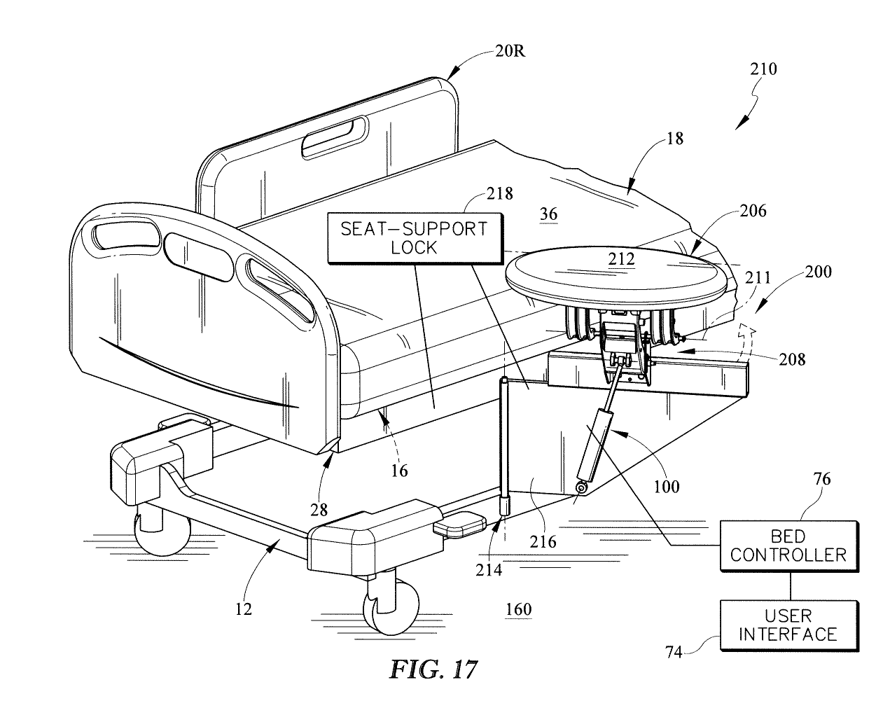

Another embodiment of a hospital bed 210 comprises the frame 14, the deck 16, the mattress 18, and a seating unit 200 as shown in FIGS. 15-17. The seating unit 200 is coupled to the frame 14 to pivot about a vertical pivot axis 202 between a first position shown in FIG. 15 and a second position shown in FIG. 16. The seating unit 200 illustratively includes a seat support 204, a seat 206, and a seat pivot 208. The seat pivot 208 interconnects the seat 206 and the seat support 204 to cause the seat 206 to pivot about a horizontal seat axis 211 between a vertical position shown in FIGS. 15 and 16 and a horizontal position shown in FIG. 17. When the seat 206 is in the horizontal position, support surface 212 included in the seat 206 forms a generally horizontal plane. When the seat 206 is in the vertical position, the support surface 212 forms an angle plane which is not generally horizontal as shown in FIG. 15.

As shown in FIG. 15, the seat support 204 includes a support pivot 214 coupled to the frame 14 in a fixed position relative to the frame 14 and a support plate 216 coupled to the support pivot 214 to pivot about the vertical pivot axis 202. When the seat support 204 is in the first position, the support plate 216 is arranged to extend along the deck 16 parallel to the longitudinal axis 26. When the seat support 204 is in the second position, the support plate 216 is arranged to extend outwardly away from the frame 14 and the deck 16 as shown in FIGS. 16 and 17.

The seat 206 is coupled to the seat pivot 208 to move relative to the support plate 216 between the vertical and the horizontal positions. As an example of use, the seat 206 and support plate 216 are rotated from the first position to a second position. Next, the seat 206 is rotated from the vertical position to the horizontal position. As a result, the seating unit 200 is now in a use position in which a caregiver can sit on the support surface 212 and attend to a patient resting on the mattress 18 of the hospital bed 210.

When the seat support 204 is in the first position and the seat 206 is in the vertical position, the seating unit 200 is in the storage position as shown in FIG. 15. When the seat support 204 is in the second position and the seat 206 is in the vertical position, the seating unit 200 is in an intermediate position as shown in FIG. 16.

As shown in FIGS. 15-17, the seating unit 200 also includes an actuator 100 that also interconnects the seat 206 and the seat support 204 to cause the seat 206 to move between the vertical and the horizontal positions. The actuator 100 is movable between the retracted position which causes the seat 206 to be in the vertical position and the extended position which causes the seat 206 to be in the horizontal position.

The seating unit 200 also includes a seat-support lock 218 which is coupled to the frame 14 to interconnect selectively the seat support 204 to the frame 14. As an example, seat-support lock 218 may be arranged in a locked position where movement of the support plate 216 relative to the frame 14 is blocked and a freed position where movement of the support plate relative to the frame 14 is permitted. As an example, the caregiver or patient may use a user interface to cause the seat-support lock 218 to be moved to the freed position and cause the seat 206 to move from the vertical position to the horizontal position by way of the actuator 100.

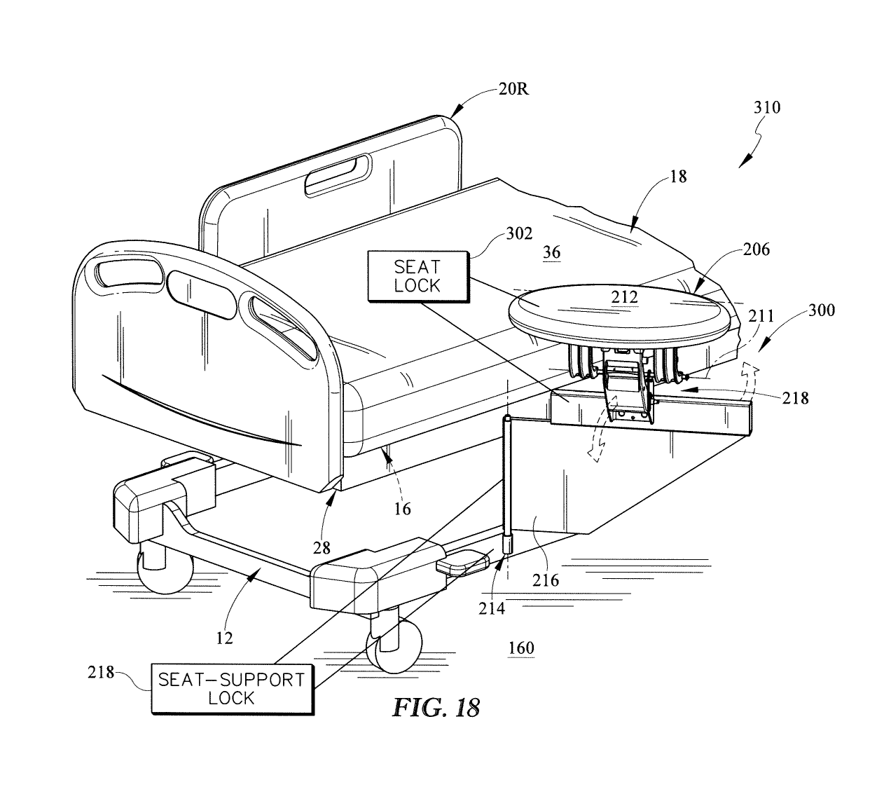

Another embodiment of a hospital bed 310 comprises the frame 14, the deck 16, the mattress 18, and a seating unit 300 as shown in FIG. 18. The seating unit 300 includes the seat support 204, the seat 206, the seat pivot 208, the seat-support lock 218, and a seat lock 302 as shown in FIG. 18. In comparison to seating unit 200, seating unit 300 lacks the actuator 100 and includes the seat lock 302. The seat lock 302 is configured to block movement of the seat 206 relative to the seat support 204. As an example of use, the caregiver may manually disengage the seat lock 302 from the locked position to the freed position, move the seat 206 from the vertical position to the horizontal position, and then re-engage the seat lock 302. As another example, the seat lock 302 may be biased toward the locked position.

Although certain illustrative embodiments have been described in detail above, variations and modifications exist within the scope and spirit of this disclosure as described and as defined in the following claims.

1. A patient support apparatus comprising
a base,
a frame coupled to the base to move relative to the base,
a deck supported by the frame and movable relative to the frame,
a siderail assembly including a linkage coupled to the frame below the deck to move relative to the frame between a raised position and a lowered position, a barrier coupled to the linkage to move relative to the linkage between a vertical position in which the barrier is in a vertical plane and a horizontal position in which the barrier is in a horizontal plane orthogonal with the vertical plane, and a linkage mover interconnecting the linkage and the frame to cause the linkage and the barrier to move between the raised and lowered positions when the barrier is in one of the vertical and horizontal position.

2. The patient support apparatus of claim 1, wherein the linkage mover includes a support plate coupled to the frame in a fixed position, an actuator coupled to the support plate to move relative to the support plate between an extended position in which the actuator has an extended length and a retracted position in which the actuator has a retracted length, and a link arm interconnecting the linkage and the actuator to cause the linkage to move from the lowered position to the raised position in response to movement of the actuator to the refracted position to the extended position.

3. The patient support apparatus of claim 2, wherein the extended length is greater than the retracted length.

4. The patient support apparatus of claim 1, wherein the siderail assembly is in a vertical raised position when the barrier is in the vertical position and the linkage is in the raised position.

5. The patient support apparatus of claim 4, wherein the barrier is spaced apart above ground a first distance when the siderail assembly is in the vertical raised position.

6. The patient support apparatus of claim 5, wherein the siderail assembly is in a vertical lowered position when the barrier is in the vertical position and the linkage is in the lowered position.

7. The patient support apparatus of claim 6, wherein the barrier is spaced apart above ground a second distance when the siderail assembly is in the vertical lowered position and the second distance is less than the first distance.

8. The patient support apparatus of claim 1, wherein the siderail assembly is in a horizontal raised position when the barrier is in the horizontal position and the linkage is in the raised position.

9. The patient support apparatus of claim 8, wherein the barrier is spaced apart above ground a first distance when the siderail assembly is in the horizontal raised position.

10. The patient support apparatus of claim 9, wherein the siderail assembly is in a horizontal lowered position when the barrier is in the horizontal position and the linkage is in the lowered position.

11. The patient support apparatus of claim 10, wherein the barrier is spaced apart above ground a second distance when the siderail assembly is in the horizontal lowered position and the second distance is less than the first distance.

12. The patient support apparatus of claim 1, wherein the siderail assembly further includes a lock unit including a barrier lock movable between a locked position in which the barrier is blocked from moving relative to the linkage and a freed position in which the barrier is free to move relative to the linkage.

13. The patient support apparatus of claim 12, wherein the lock unit further includes a lock controller including an actuator coupled to the barrier to pivot about an actuator pivot axis between an engaged position and a disengaged position, a relay, and a lock mover coupled to the barrier to move the barrier lock from the locked to the freed positions in response to the relay providing electrical power to the lock mover in response to movement of the actuator from the disengaged position to the engaged position.

14. A patient support apparatus comprising
a base,
a frame coupled to the base to move relative to the base,
a deck supported by the frame and movable relative to the frame, and
a siderail assembly including a linkage coupled to the frame below the deck to move relative to the frame between a raised position and a lowered position, a barrier coupled to the linkage to pivot about a barrier axis relative to the linkage between a vertical position in which an inner surface of the barrier that faces the deck defines a vertical plane and a horizontal position in which the inner surface of the barrier defines a horizontal plane orthogonal with the vertical plane, and a linkage mover interconnecting the linkage and the frame to cause the barrier to move from the raised position in which the barrier is a first distance above ground to the lowered position in which the barrier is a smaller second distance above ground.

15. The patient support apparatus of claim 14, wherein the inner surface of the barrier, when the barrier is in the vertical position, remains parallel to the vertical plane during movement of the barrier between the raised position to the lowered position.

16. The patient support apparatus of claim 15, wherein the inner surface of the barrier, when the barrier is in the horizontal position, remains parallel to the horizontal plane during movement of the barrier between the raised and lowered positions.

17. The patient support apparatus of claim 14, wherein the linkage mover includes a support plate coupled to the frame in a fixed position, an actuator coupled to the support plate to move relative to the support plate between an extended position in which the actuator has an extended length and a retracted position in which the actuator has a retracted length, and a link arm interconnecting the linkage and the actuator to cause the linkage to move from the lowered position to the raised position in response to movement of the actuator from the retracted position to the extended position and the actuator has a first end coupled to the support plate to pivot about a first pivot axis and a second end coupled to the linkage to pivot about a second pivot axis, the first pivot axis is fixed relative to the support plate, and the second pivot axis moves along an arcuate slot formed in the support plate relative to the support plate as the actuator moves from the retracted position to the extended position.

18. The patient support apparatus of claim 17, wherein the actuator is powered.

19. A patient support apparatus comprising
a base including two long sides spaced apart from one another and two short sides spaced apart from one another and interconnecting the two long sides,
a frame coupled to the base to move relative to the base,
a deck supported by the frame and movable relative to the frame, and
a seating unit including a seat support coupled to the base to pivot about a vertical pivot axis between a first position in which the seat support extends along a long side of the frame and second position in which the seat support extends away from the two long sides, a seat, and a seat pivot interconnecting the seat and the seat support to cause the seat to pivot about a horizontal seat pivot axis between a horizontal position in which a support surface of the seat adapted to support a user sitting on the seat defines a generally horizontal plane and a vertical position in which the support surface defines a generally vertical plane and
wherein the seating unit is in a storage position when the seat is in the vertical position and the seat support is in the first position, the seating unit is in an intermediate position when the seat is in the vertical position and the seat support is in the second position, and the seating unit is a use position when the seat is in the horizontal position and the seat support is in the second position.

20. The patient support apparatus of claim 19, wherein the seating unit further includes an actuator coupled to the seat support and to the seat to cause the seat to pivot from the vertical position to the horizontal position upon extension of the actuator from a first length to a second length greater than the first length.
